(19) United States
(12) Patent Application Publication
(10) Pub. No.: US 2014/0245129 A1
(43) Pub. Date: Aug. 28, 2014

(54) Method And System For Dynamically Positioning A PIN Entry Box In A Terminal Display

(71) Applicant: Joel Z. Sapul, (US)

(72) Inventor: Joel Z. Sapul, Makati City (PH)

(21) Appl. No.: 14/185,926

(22) Filed: Feb. 21, 2014

(30) Foreign Application Priority Data
Feb. 22, 2013 (PH) 1-2013-000068
Dec. 19, 2013 (SG) 201309418-0

(51) Int. Cl. G06F 17/22

(52) U.S. Cl. CPC G06F 17/2247
USPC 715/234

(57) ABSTRACT

The present invention provides a system that comprises a random number generation algorithm, where the random number generation algorithm is able to generate a random number in association with a GET HTTP request from a Terminal Device and the generated random number is associated with a baseline reference of a PIN Entry Box, so that the PIN Entry Box is dynamically displayed with the proper time delay to display on a terminal display of the Terminal Device. The present invention also provides a method of dynamically positioning the PIN Entry Box on the terminal display using the random number generation algorithm.

### FIELD OF THE INVENTION

The present invention relates generally to internet communications, and more particularly to a method and system for dynamically positioning a PIN Entry Box in a terminal display when a user initiates an application of interact browsers.

### BACKGROUND OF THE INVENTION

Internet service is part of our daily lives now. There are many Internet accesses available in most establishments either using wireless or wired network. User password protection has been the standard feature for accessing open Internet networks among enterprises, companies or home users. The techniques for implementing the user password protection have lots of variants and are sometimes up to the designer of the authentication program or the owner of the network on which security methods are used.

Current Wireless Security in accessing internet uses WiFi signal or the 802.11x protocols where x can be A, B, G, N, or any other future standards. The implementation of the WiFi access security takes several ways. One is a Secured or Lock WiFi access network where the Win Access Point or Wireless Router is password protected either by WEP and WPA keys or other similar security measures; thus a user has to provide an authentication code in the security input box before the internet can be accessed. If the authentication code entered is correct, the user can access the WiFi. If the authentication code entered is not correct, the user is denied the privilege to access the internet. This way is easy to set up, but any modification of an administration page with the security input box needs to update and open the administration page. Not many people can just open the configuration page of a router because this is a very complicated and delicate configuration in which a person with networking background is needed. Also, since the WEP or WPA keys are statically configured in a Terminal or Access Point Device, any user or even the Terminal Device can memorize the same code and access the Internet every time a user or that device enters the WiFi zone unless this security key is changed and updated by the administrator from time to time.

The second way is to use an Open WiFi but use an Access Controller centrally, but this will redirect a user to a Captive Portal with a Security code question or PIN request. This captive Portal page is the primary page that displays the logo or any other designs of the operating company, some picture(s) and text contents on how to use the service, and a PIN Entry Box that asks for the Password or PIN from the user. The user has to provide the correct PIN or Password to the PIN Entry Box before a user can access the Internet. The PIN Entry Box is normally located in a specific location within the Captive Portal page.

The third way uses 3G offload technique that uses automatic authentication or using EAP variant methods such as EAP-SIM, EAP-TLS or any similar authentications or Passpoint method to provide automatic authentication for any subscribed user to Internet service. These three modes have pros and cons but all provide certain layers of security either using PINs, codes or automatic authentications, before a user can access the internet.

Most of the WiFi securities implemented in the Philippines today and in some part of the world use WEP/WPA or Open SSID with UserName/Password or PIN. They provide a layer of protection to the owner of WiFi in terms of giving only the access to known user(s) with the right Key(s) or PIN code(s).

One application for the use of Open SSID and central or distributed Access Controller method is that the operator of WiFi can select a Captive Portal page to post or advertise to a user since the Captive Portal is a page that can be designed for the purposes of not only entering PIN or security codes but also advertising by adding pictures and texts to the same Captive Portal page. However, the Captive Portal page is currently set up in such a way that the PIN Entry Box for entering PIN or security codes is fixed on a certain point of the screen page; thus a user can memorize the location/position of the PIN Entry Box after several uses, and then may pay less attention to other advertising materials such as pictures and texts. Therefore, the effectiveness of the advertisement on the Captive Portal page will be challenged.

### SUMMARY OF THE INVENTION

One objective of the present invention is to increase of the viewing and/or exposure percentage of the contents that normally are part of the Captive Portal page.

One aspect of the present invention provides a system of dynamically positioning of a Pin Entry Box on a terminal display. In one embodiment, the system comprises a Terminal Device with Internet access capacity of accessing internet via wired network or WiFi wireless network; wherein the terminal Device comprises a terminal display for being able to display desired captive portal images and a PIN Entry Box, and has an IP address that is attached to any request it sends out; an Access Controller with redirection functionality; wherein the Access Controller comprises an electronic storage medium for storing an internal database and requisite programs and/or contents; and a processor for processing the stored programs; an Internet for transmission of electronic information; a Central Server communicatively coupled via the Internet with the Access Controller; wherein the Central Server comprises an electronic storage medium for storing information, media contents and an internal database; a Central Database communicatively coupled with the Central Server; and a random number generation algorithm embedded in the electronic storage medium of either the Access Controller or the Central Server; wherein the Access Controller is communicatively coupled to the Central Server via the Internet and processes back the HTML reply from the Central Database to the Terminal Device for being displayed on the terminal display; wherein when the Terminal Device sends a request, a random number is generated by the random number generation algorithm, the Central Database selects a baseline reference, media contents, time delay to display and position of the PIN Entry Box based on the random number received; so that the PIN Entry Box displayed on the terminal display changes its position and time delay to display within the baseline reference.

In a further embodiment of the system, it further comprises a connection interface disposed between the Terminal Device and the Access Controller so as to communicatively couple the Terminal Device and the Access Controller. In yet a further embodiment of the system, the connection interface is a RJ-45 LAN connection, a Wireless connection via WiFi, or any other suitable interfaces in the future.

In another embodiment of the system, it further comprises a modem or router disposed between the Internet and the Central Server so as to communicatively couple the Internet and the Central Server. In a further embodiment of the system, the Terminal Device is a computer, laptop, tablet or mobile phone.

In another embodiment of the system, the terminal display is built in or external.

Another aspect of the present invention provides a method of dynamically positioning a PIN Entry Box on a terminal display of a Terminal Device in a system comprising an Access Controller, an Internet, a Central Server and a Central database. In one embodiment, the method comprises initiating by a Terminal Device a GET HTTP request to the Access controller; contacting the Central Server via the Central Server's IP address registered in the Access Controller and sending a Get Info request to the Central Server over the internet by the Access Controller; storing the MAC address of the Access Controller, generating a random number, and pairs the MAC address and random number for transmission to a Central Database by the Central Server; sending the paired MAC address and the random number to the Central Database by the Central Server; attaching the random number to the MAC address of the Access Controller by the Central Database; selecting a baseline reference and position of the PIN Entry Box based on the random number received by the Central Database; selecting the images based on the MAC address and the attached random number by the Central Database; selecting the time delay to display the PIN Entry Box based on random numbers, sending a return value to the Central Server with the MAC address of the Access controller, the baseline reference and position of the PIN Entry Box, images codes, time delay to display and the position of the image code that will appear on a terminal display of the Terminal Device by the Central Database; forwarding the baseline reference and position of the PIN Entry Box, images codes, time delay, and the position of the image code back to the Access controller by the Central Server; interpreting the various codes and values received from the Central Server by the Access Controller; and displaying the images and the Pin Entry Box properly located, at the right delay time and arranged in the terminal display based on the random number.

In another embodiment of the method, the baseline reference is an imaginary rectangle, circle, triangle or random baseline.

In another embodiment of the method, the random number can be generated by the Access Controller.

The present invention completely changes everything of the Captive Portal page, and a user has to look for the Pin Entry Box every time when he/she opens the Captive Portal page because the position/location of the PIN Entry Box is changed every time in the terminal display. With this, the user has to browse and look to the entire display page, thereby increasing the chances of certain contents to be viewed and noticed by internet users or WiFi users.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is a block diagram of the system in accordance with one embodiment of the present invention.

FIG. 2 is a flowchart of the method of dynamically positioning a PIN Entry Box on a terminal display in accordance with one embodiment of the present invention.

FIG. 3 shows exemplary baseline shapes that a Central Database can use as an imaginary pattern where the PIN Entry box can be positioned.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides a system of dynamically positioning of a Pin Entry Box on a Captive Portal page. The system dynamically changes the position/location of the PIN Entry Box on the Captive Portal page. One direct application of the present invention is to enhance the current Open SSID with Captive Portal page and PIN Entry box. By changing the position/location of the PIN Entry Box, a user has to browse the entire Captive Portal page in order to locate the PIN Entry Box; thus the user has to spend more time in the process of locating the PIN Entry Box, resulting in the increase of the viewing and/or exposure percentage of the contents that normally are part of the Captive Portal page.

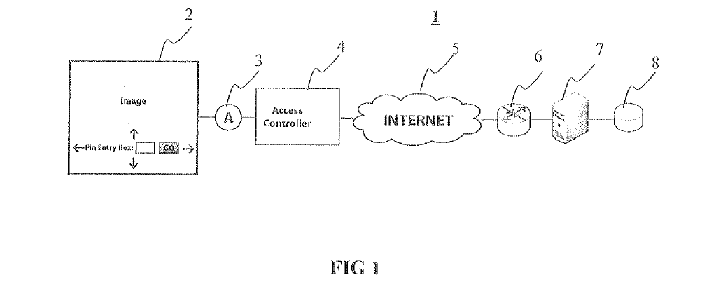

Referring now to FIG. 1, there is provided a block diagram of the system in accordance with one embodiment of the present invention. As shown in FIG. 1, the network 1 comprises a Terminal Device 2, a connection interface 3, an Access Controller 4, an Internet 5, a modem/router 6, a Central Server 7, and a Central Database 8. The connection interface 3 communicatively couples the Terminal Device 2 and the Access Controller 4 that is communicatively coupled with the Internet 5, and the modem/router 6 communicatively couples the Internet 5 and the Central Server 7 that is communicatively coupled with the Central Database 8. All components of the system are common in a typical communication network; thus, the known details of each component and their conventional operations will not be described herein in details in order not to obscure the principles of the present invention.

The Terminal Device 2 Display can be any device with Internet access capacity such as a computer, laptop, tablet or mobile phone. The Terminal Device 2 can access interact via wired network or WiFi wireless network. The terminal Device 2 comprises a terminal display for displaying interact or HTTP contents, where the terminal display can be built in or external. The Terminal Device 2 has an IP address that will be attached to any request it sends out. The terminal display of the Terminal device 2 displays the desired captive portal images and the PIN Entry box that changes the position within the baseline reference.

The connection interface 3 is communicatively coupled with the Terminal device 2 and the Access Controller 4. The connection interface 3 can be a RJ-45 LAN connection, a Wireless connection via WiFi, or any other suitable interfaces in the future. As shown in FIG. 1, the connection interface 3 is represented by the letter A with circle around it.

The Access Controller 4 can be any access controller appliance/device that can provide redirection functionality to the Central Server 7 via the internet and process back the HTML reply from the Central Database 8 to the Terminal Device 2 for being displayed on the terminal display. The Access Controller 4 is connected to the internet via available technologies such as DSL, fiber optic, cable TV modem, wireless device or any communication equipment. The Access Controller 4 comprises an electronic storage medium for storing an internal database and requisite programs and a processor for processing the stored programs. When the Access Controller 4 receives an HTTP request from the Terminal Device 2 via the connection interlace 3, the Access Controller 4 maps the IP address of the Terminal Device into its internal database to generate an identification tag to the received HTTP request, and then sends the received HTTP request with the identification tag to the Central Server 7 over the Internet 5 via the modem/router 6, where the IP address or URL address of the Central Server 7 is stored in the internal database of the Access Controller 4. In certain embodiments, the Access Controller 4 has a random number generation algorithm embedded in its electronic storage medium. When the Access Controller 4 receives a GET HTTP request from a Terminal Device 2, the random number generation algorithm will generate a random number and send the generated random number together with the GET HTTP request with its identification tag to the Central Server 7. The random number is a numeric representation of the position or coordinates of the PIN Entry Box that will be processed by the Access Controller and displayed on the terminal display. Each random number corresponds to the position/location of the PIN Entry Box, and the image value code, type and position when they are displayed on the terminal display. The position/location of the PIN Entry Box can be pre-defined following a pre-defined shape or pattern where the user can easily locate the general location of the PIN Entry Box as discussed hereinbelow in details. When the Access Controller 4 receives the reply from the Central Server 7, it interprets the various codes and val ues received and uses them to search from its internal database folders for the equivalent file page, that were provisioned and stored previously, and use the right page file values that will be inserted to the HTML script that will be displayed to the Terminal Device 2.

The Central Server 7 is an electronic apparatus capable of running the back-end processes of the present invention. The Central Server 7 receives a HTTP protocol from the Access Controller 4, and responds to the Access Controller 4 with the right HTTP Captive Portal image or combination of instructions that can be interpreted by the Access Controller 4 and then displayed on the terminal display of the Terminal Device 2. If the Access Controller 4 generates the random number as described above, the Central Server 7 will register the MAC address of the Access Controller 4 and pair the MAC address with the generated random number, and then forward the paired information to the Central Database 8. In certain embodiments, the random number generation algorithm is embedded in the Central Server 7, where the random number generator assigns the position of the PIN Entry Box. The Central Server 7 has a connection to the Central Database 8, where the Central Database 8 stores the MAC address, Shapes, Location, Portal images files, Time and Position values of the PIN Entry Box taken from the corresponding random number generated by the Central Server 7. The Central Database 8 attaches the random number to the MAC address of the Access Controller 4, selects the baseline shape and the position of the PIN Entry Box based on the random number received, selects the Images to be used by the captive portal based on the MAC address and the attached random number, and sends a return value to the Central Server 7 with the MAC address of the Access controller 4, Shape baseline to be used by the PIN Entry Box, Images codes, time delay to display value, and the position of the image code that will appear on the terminal display.

These internal data such as MAC address, Shapes, Location, Images, time delay and Position coordinates are pre-stored and configured in the database through provisioning procedure together with the agreed random number values expected from the Central Database 8. The provisioning procedures are not part of the scope of the present invention and will not be described herein in details.

The information to be displayed on the Terminal Device 2 is the collaboration of the Access Controller 4, Central Server 7 and Central Database 8 on how the captive portal image will look like, the layout of the image, and finally the position of the PIN Entry Box, and how long to delay the display of the PIN Entry Box, all in all that makes up the invention.

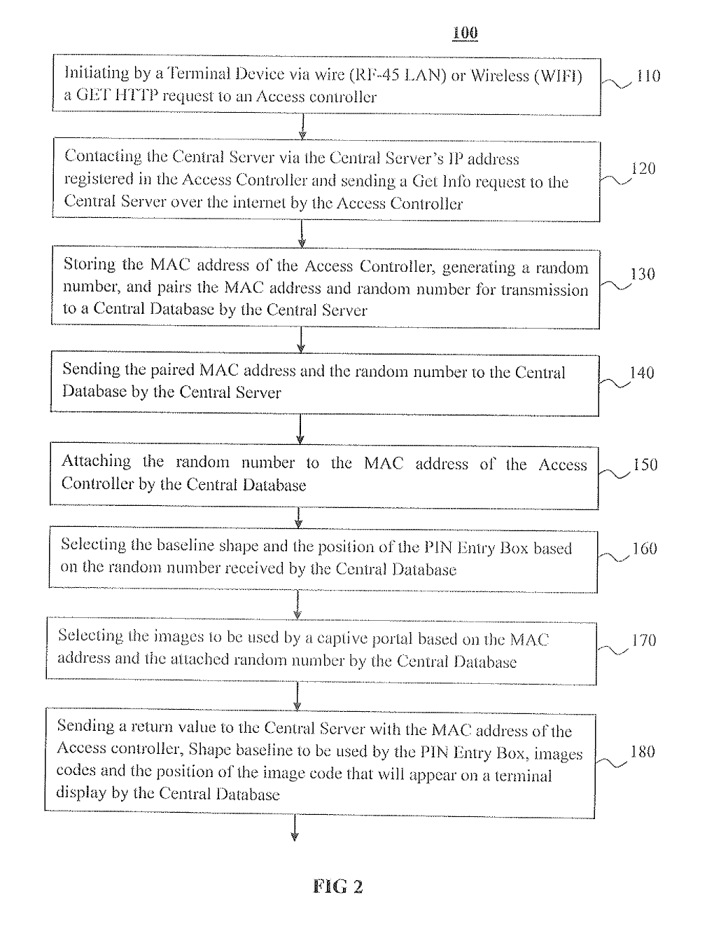

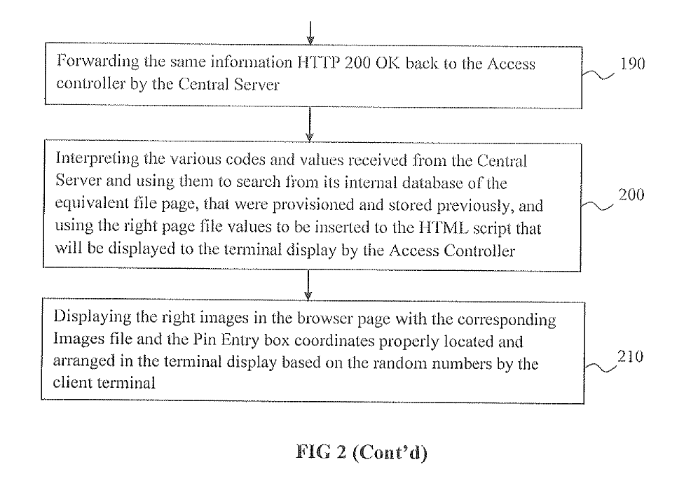

Referring now to FIG. 2, there is provided a flowchart of the method of dynamically positioning a PIN Entry Box on a terminal display in accordance with one embodiment of the present invention. For the only purpose of illustration of the principles of the present invention, the random number generation algorithm is presumably embedded in the Central Server. It is to be noted that the flowchart describes the few critical operations of the internet connection processes employed in the present invention, from the request for an internet connection up to the display of the Captive Portal only; the succeeding operations of the internet connections after the display of the Captive Portal will not be discussed herein. It is to be further noted that the operations are numbered to easily track what is being explained here; it does not limit the operations in such a numbered manner.

The method 100 starts when a Terminal Device capable of internet connection, either via wire (RF-45 LAN) or Wireless (WIFI), requests to connect to the internet using the WiFi SSID or through wired network protocol 110. The Terminal Device initiates a GET HTTP request to an Access controller, and the GET HTTP request is sent via protocol over interact. This is a typical browser command when a client user intends to access the interact.

The Access Controller contacts the Central Server via the Central Server's IP address registered in the Access Controller and sends a Get Info request to the Central Server over the interact 120.

The Central Server stores the MAC address of the Access Controller, generates a random number, and pairs the MAC address and random number for transmission to the Central Database 130. The Central Server is embedded with one random number generator algorithm that generates a random number by processing the values such as MAC address of the Access Controller, time of the day, IP address of the Terminal Device. The random number is a numeric representation of the position or coordinates of the PIN Entry Box that will be processed by the Access Controller and displayed on the terminal display. Each random number corresponds to the position/location of the PIN Entry Box, and the image value code, type and position when they are displayed on the terminal display and the time delay to display the PIN entry Box. The position/location of the PIN Entry Box can be pre-defined following a pre-defined shape or pattern where the user can easily locate the general location of the PIN Entry Box as discussed hereinbelow in details.

The Central Server sends the paired MAC address and the random number to the Central Database 140.

The Central Database attaches the random number generated by the Central Server to the MAC address of the Access Controller 150.

The Central Database selects the baseline shape and the position of the PIN Entry Box based on the random number received 160.

The Central Database selects the Images to be used by the captive portal based on the MAC address and the attached random number 170.

The Central Database sends a return value to the Central Server with the MAC address of the Access controller, Shape baseline to be used by the PIN Entry Box, Images codes, time delay, and the position of the image code that will appear on the client terminal display 180.

The Central Server forwards the same information HTTP 200 OK back to the Access controller 190.

The Access Controller interprets the various codes and values received from the Central Server and uses them to search from its internal database of the file folders with the equivalent file pages, that were provisioned and stored previously, and use the right page file values that will be inserted to the HTML script that will be displayed to the client terminal devices or mobile devices 200.

The client terminal displays the right images in the browser page with the corresponding Images file and the Pin Entry box coordinates properly located and arranged in the display browser screen based on the random numbers generated by the Central database. The resulting page is a random PIN Entry Box position in a captive portal display controlled by the Central Server 210.

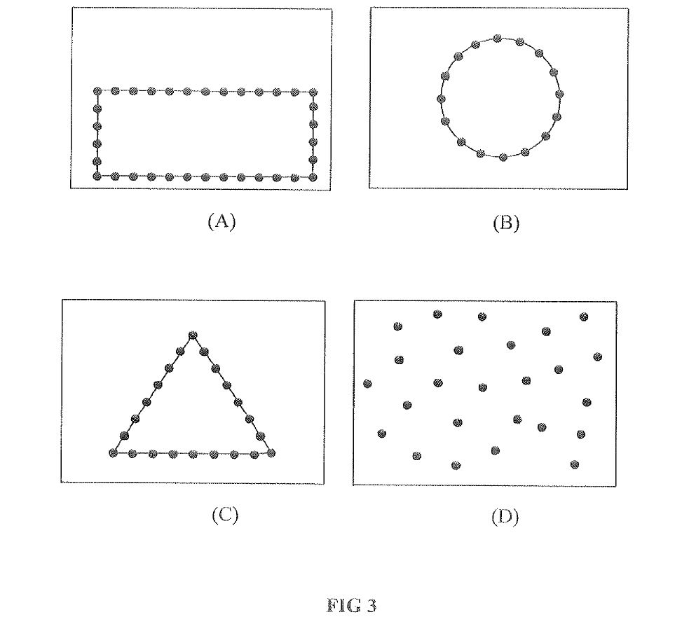

Referring now to FIG. 3, there are provided exemplary baseline shapes that the Central Database can use as an imaginary pattern where the PIN Entry box can be positioned. FIG. 3A shows an imaginary rectangle baseline where each dot corresponds to a value of the random number being generated by the Central Server. The lesser number of dot positions, the lesser random number will be processed. The bigger number of dot positions, the bigger number of random number processed. With this set up, the Captive Portal can be designed in such a way that the PIN Entry Box can be position to any of these baseline points so that it can enhance viewing direction of the user to the contents within the rectangle baseline of an area. This is also true for FIGS. 3B and 3C where contents can be located within a circle or triangle to enhance the viewing focus of the user to these baselines points area. This will then increase the chances of the content to be noticed and seen by the user depending on where the PIN Box Entry is positioned. On the other hand, FIG. 3D is another imaginary pattern for reference points within the display terminal screen where any point can be a PIN Entry Box location point. By using the entire screen as a possible PIN Entry box location, this will then allow the user to browse the entire display screen to locate the PIN Entry Box. This will then enhance the viewing focus of the user to see the entire display since the user will have to look for the PIN Entry Box and chances are it will see the other information and contents of the captive portal. Again, though this is not a fool proof invention, user response to the contents within the captive portal depends on how colorful and attractive the image are to attract the eyes of the user during the searching period of the eyes looking for the PIN Entry box.

Based on the random numbers generated by the central server, the PIN Entry Box appearance can also be set to have delay timer appearance based on the same random number so that the client user will have to search the entire page to look for the PIN Entry Box. Only after a predetermined time will the PIN Entry box will appear in the baseline shape. So with this feature, we used the random number generated by the central database to control the position of the PIN Entry Box, and the time delay to display the same PIN Entry Box.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. A system of dynamically positioning of a Pin Entry Box on a terminal display, said system comprising:
a Terminal Device with Internet access capacity of accessing internet via wired network or WiFi wireless network; wherein the terminal Device comprises a terminal display for being able to display desired captive portal images and a PIN Entry Box, and has an IP address that is attached to any request it sends out;
an Access Controller with redirection functionality; wherein the Access Controller comprises an electronic storage medium for storing an internal database and requisite programs and a processor for processing the stored programs;
an Internet for transmission of electronic information;
a Central Server communicatively coupled via the Internet with the Access Controller; wherein the Central Server comprises an electronic storage medium for storing information and an internal database;
a Central Database communicatively coupled with the Central Server; and
a random number generation algorithm embedded in the electronic storage medium of either the Access Controller or the Central Server;
wherein the Access Controller is communicatively coupled to the Central Server via the Internet and processes back the HTML reply from the Central Database to the Terminal Device for being displayed on the terminal display;
wherein when the Terminal Device sends a request, a random number is generated by the random number generation algorithm, the Central Database selects a baseline reference and position of the PIN Entry Box based on the random number received;
so that the PIN Entry Box displayed on the terminal display changes its position within the baseline reference.

2. The system of claim 1, further comprising a connection interface disposed between the Terminal Device and the Access Controller so as to communicatively couple the Terminal Device and the Access Controller.

3. The system of claim 2, wherein the connection interface is a RJ-45 LAN connection, a Wireless connection via WiFi, or any other suitable interfaces in the future.

4. The system of claim 1, further comprising a modem or router disposed between the Internet and the Central Server so as to communicatively couple the Internet and the Central Server.

5. The system of claim 1, wherein the Terminal Device is a computer, laptop, tablet or mobile phone.

6. The system of claim 1, wherein the terminal display is built in or external.

7. A method of dynamically positioning a PIN Entry Box on a terminal display of a Terminal Device in a system comprising an Access Controller, an Internet, a Central Server and a Central database, said method comprising:
initiating by a Terminal Device a GET HTTP request to the Access controller;
contacting the Central Server via the Central Server's IP address registered in the Access Controller and sending a Get Info request to the Central Server over the Internet by the Access Controller;
storing the MAC address of the Access Controller, generating a random number, and pairs the MAC address and random number for transmission to a Central Database by the Central Server;
sending the paired MAC address and the random number to the Central Database by the Central Server;
attaching the random number to the MAC address of the Access Controller by the Central Database;
selecting a baseline reference and position of the PIN Entry Box based on the random number received by the Central Database;
selecting the images based on the MAC address and the attached random number by the Central Database;
selecting the time delay to display the PIN Entry Box based on random numbers
sending a return value to the Central Server with the MAC address of the Access controller, the baseline reference and position of the PIN Entry Box, images codes, time delay to display value and the position of the image code that will appear on a terminal display of the Terminal Device by the Central Database;
forwarding the baseline reference and position of the PIN Entry Box, images codes and the position of the image code back to the Access controller by the Central Server;
interpreting the various codes and values received from the Central Server by the Access Controller; and
displaying the images and the Pin Entry Box properly located and arranged in the terminal display based on the random number.

8. The method of claim 7, wherein the system further comprises a connection interface disposed between the Terminal Device and the Access Controller so as to communicatively couple the Terminal Device and the Access Controller.

9. The method of claim 8, wherein the connection interface is a RJ-45 LAN connection, a Wireless connection via WiFi, or any other suitable interfaces in the future.

10. The method of claim 7, wherein the system further comprises a modem or router disposed between the Internet and the Central Server so as to communicatively couple the Internet and the Central Server.

11. The method of claim 7, wherein the Terminal Device is a computer, laptop, tablet or mobile phone.

12. The method of claim 7, wherein the terminal display is built in or external.

13. The method of claim 7, wherein the baseline reference is an imaginary rectangle, circle, triangle or random baseline.

14. The method of claim 7, wherein the random number can be generated by the Access Controller.
